(19) United States
(12) Patent Application Publication
(10) Pub. No.: US 2023/0418118 A1
(43) Pub. Date: Dec. 28, 2023

(54) DISPLAY DEVICE

(71) Applicant: Japan Display Inc., Tokyo (JP)

(72) Inventors: Shunichi KIMURA, Tokyo (JP); Toshiharu MATSUSHIMA, Tokyo (JP)

(73) Assignee: Japan Display Inc., Tokyo (JP)

(21) Appl. No.: 18/463,344

(22) Filed: Sep. 8, 2023

Related U.S. Application Data
(63) Continuation of application No. PCT/JP2022/001522, filed on Jan. 18, 2022.

(30) Foreign Application Priority Data
Mar. 10, 2021 (JP) 2021-038507

(51) Int. Cl. G02F 1/1343; G02F 1/1335; G02F 1/1337; G02F 1/137

(52) U.S. Cl. CPC G02F 1/134363; G02F 1/133528; G02F 1/133707; G02F 1/13706

(57) ABSTRACT

According to one embodiment, a display device includes a first liquid crystal panel, a second liquid crystal panel. Each of the first liquid crystal panel and the second liquid crystal panel includes a first substrate including a common electrode and a pixel electrode, a second substrate, and a liquid crystal layer. The pixel electrode includes a plurality of branch portions extending in a first direction, and a trunk extending in a second direction and connected to the plurality of branch portions. The pixel electrode of the first liquid crystal panel and the pixel electrode of the second liquid crystal panel have a same shape and overlap each other.

### CROSS-REFERENCE TO RELATED APPLICATIONS

This application is a Continuation Application of PCT Application No. PCT/JP2022/001522, filed Jan. 18, 2022 and based upon and claiming the benefit of priority from Japanese Patent Application No. 2021-038507, filed Mar. 10, 2021, the entire contents of all of which are incorporated herein by reference.

### FIELD

Embodiments described herein relate generally to a display device.

### BACKGROUND

A liquid crystal display device of In-Plane-Switching (IPS) mode or Fringe Field Switching (FFS) mode is well known as an example of a display device. In these lateral electric field type liquid crystal display devices, one of a pair of substrates opposed to each other via a liquid crystal layer comprises a pixel electrode and a common electrode. Liquid crystal molecules in the liquid crystal layer are driven using an electric field generated between the pixel electrode and the common electrode.

In recent years, a method of increasing a response speed and improving the alignment stability as compared with the conventional FFS mode has also been proposed.

### BRIEF DESCRIPTION OF THE DRAWINGS

FIG. 1 is a view showing an example of the display device DSP.

FIG. 2 is a view showing an example of the first liquid crystal panel PNL1 and the second liquid crystal panel PNL2 shown in FIG. 1.

FIG. 3 is a cross-sectional view showing an example of a structure of the first liquid crystal panel PNL1.

FIG. 4 is a cross-sectional view showing an example of a structure of the second liquid crystal panel PNL2.

FIG. 5 is a view showing an example of pixel electrodes PE1 and PE2.

FIG. 6 is a view showing another example of the pixel electrodes PE1 and PE2.

FIG. 7 is a view showing the pixel electrodes PE1 and PE2 having the shape shown in FIG. 5.

FIG. 8 is a view showing the pixel electrodes PE1 and PE2 having the shape shown in FIG. 6.

FIG. 9 is a view showing an aligned state of liquid crystal molecules LM1.

FIG. 10 is a view showing an aligned state of the liquid crystal molecules LM2.

FIG. 11A is a view illustrating the diffraction phenomenon of transmitted light.

FIG. 11B is a view illustrating the diffraction phenomenon of transmitted light.

FIG. 12 is a view illustrating the optical action of the display device DSP according to the present embodiment.

FIG. 13 is a view illustrating the optical action of the display device DSP according to the present embodiment.

FIG. 14 is a graph showing a relationship of the mode efficiency to the liquid crystal applied voltage.

FIG. 15 is a graph showing the relationship of the mode efficiency to the liquid crystal applied voltage.

FIG. 16 is a graph showing the relationship of the mode efficiency to the liquid crystal applied voltage.

FIG. 17 is a view illustrating an optical action in the display device DSP of the FFS mode.

FIG. 18 is a view illustrating the optical action in the display device according to the present embodiment.

### DETAILED DESCRIPTION

Embodiments described herein aim to provide a display device capable of improving front luminance.

In general, according to one embodiment, a display device includes: a first liquid crystal panel; a second liquid crystal panel adhered to the first liquid crystal panel; an illumination device illuminating the first liquid crystal panel; a first polarizer located between the illumination device and the first liquid crystal panel; and a second polarizer opposed to the second liquid crystal panel, each of the first liquid crystal panel and the second liquid crystal panel includes: a first substrate including a first insulating substrate, a switching element, a common electrode arranged across a plurality of pixels, a pixel electrode arranged in each of the pixels, electrically connected to the switching element, and opposed to the common electrode, and a first alignment film; a second substrate including a second insulating substrate and a second alignment film and opposed to the first substrate; and a liquid crystal layer arranged between the first substrate and the second substrate, the pixel electrode includes a plurality of branch portions extending in a first direction, and a trunk extending in a second direction intersecting with the first direction and connected to the plurality of branch portions, and the pixel electrode of the first liquid crystal panel and the pixel electrode of the second liquid crystal panel have a same shape and overlap each other.

According to the embodiments, a display device capable of improving front luminance can be provided.

Embodiments of the present invention will be described hereinafter with reference to the accompanying drawings.

The disclosure is merely an example, and proper changes within the spirit of the invention, which are easily conceivable by a person of ordinary skill in the art, are included in the scope of the invention as a matter of course. In addition, in some cases, in order to make the description clearer, the widths, thicknesses, shapes and the like, of the respective parts are schematically illustrated in the drawings, compared to the actual modes. However, the schematic illustration is merely an example, and adds no restriction to the interpretation of the invention. In addition, in the specification and drawings, structural elements which function in the same or a similar manner to those described in connection with preceding drawings are denoted by like reference numbers, detailed description thereof being omitted unless necessary.

In the figures, an X-axis, a Y-axis and a Z-axis orthogonal to each other are described to facilitate understanding as needed. A direction along the X-axis is referred to as an X-direction or a first direction, a direction along the Y-axis is referred to as a Y-direction or a second direction, and a direction along the Z-axis is referred to as a Z-direction or a third direction. A plane defined by the X-axis and the Y-axis is referred to as an X-Y plane. Viewing the X-Y plane is referred to as plan view. The first direction X and the second direction Y correspond to, for example, directions parallel to a substrate included in the display device DSP, and the third direction Z corresponds to a thickness direction of the display device DSP.

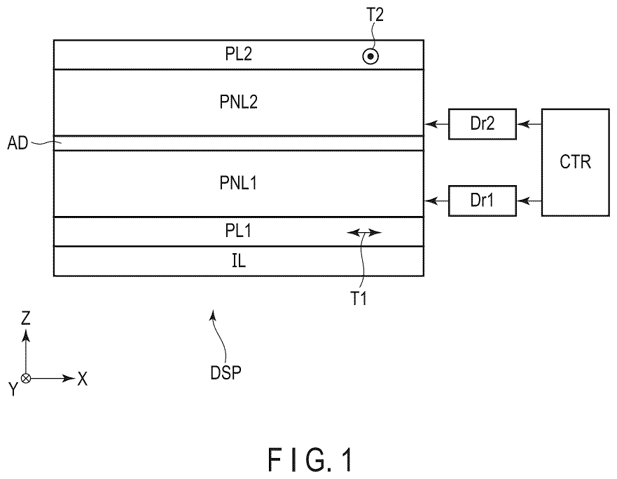

FIG. 1 is a view showing an example of the display device DSP.

The display device DSP comprises an illumination device IL, a first polarizer PL1, a first liquid crystal panel PNL1, a second liquid crystal panel PNL2, and a second polarizer PL2.

Both the first liquid crystal panel PNL1 and the second liquid crystal panel PNL2 are liquid crystal panels. The first liquid crystal panel PNL1 and the second liquid crystal panel PNL2 are opposed to each other in the third direction Z and are adhered to each other by a transparent adhesive layer AD. The illumination device IL is configured to illuminate the first liquid crystal panel PNL1.

The first polarizer PL1 is located between the illumination device IL and the first liquid crystal panel PNL1 in the third direction Z. The second polarizer PL2 is opposed to the second liquid crystal panel PNL2 in the third direction Z. The first liquid crystal panel PNL1 and the second liquid crystal panel PNL2 are located between the first polarizer PL1 and the second polarizer PL2. The first polarizer PL1 and the second polarizer PL2 are arranged to meet a crossed-Nicol relationship. In other words, a transmission axis T1 of the first polarizer PL1 and a transmission axis T2 of the second polarizer PL2 are orthogonal to each other on the X-Y plane. In one example, the transmission axis T1 is parallel to the first direction X, and the transmission axis T2 is parallel to the second direction Y.

The first liquid crystal panel PNL1 is driven by a drive unit Dr1. The second liquid crystal panel PNL2 is driven by a drive unit Dr2. The drive unit Dr1 and the drive unit Dr2 are controlled by a controller CTR.

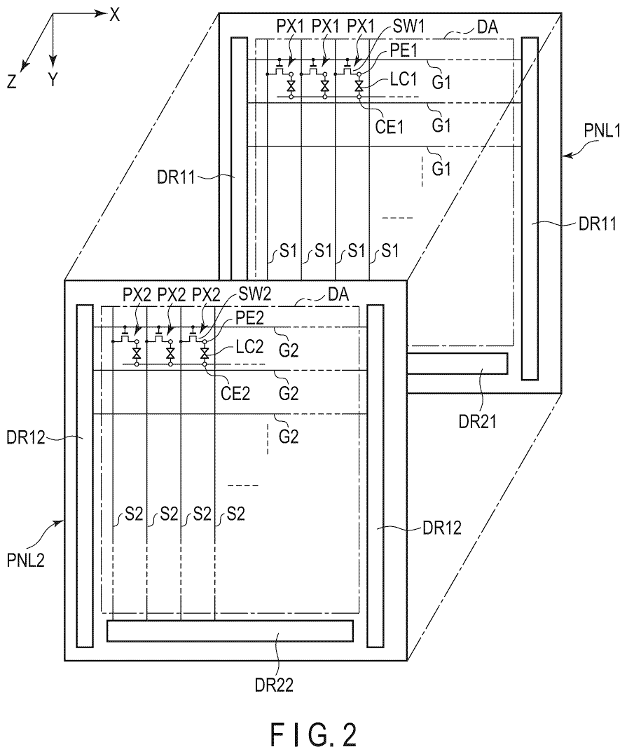

FIG. 2 is a view showing an example of the first liquid crystal panel PNL1 and the second liquid crystal panel PNL2 shown in FIG. 1.

The first liquid crystal panel PNL1 comprises a plurality of first pixels PX1, a plurality of scanning lines G1, and a plurality of signal lines S1 in the effective area AA. The plurality of scanning lines G1 and the plurality of signal lines S1 intersect with each other. In addition, the first liquid crystal panel PNL1 comprises a first driver DR11 and a second driver DR21 outside the effective area AA. The plurality of scanning lines G1 are electrically connected to the first driver DR11. The plurality of signal lines S1 are electrically connected to the second driver DR21. The first driver DR11 and the second driver DR21 are included in the drive unit Dr1 shown in FIG. 1 and controlled by the controller CTR.

Each of the first pixels PX1 comprises a switching element SW1 and a pixel electrode PE1. The switching element SW1 is electrically connected to the scanning line G1 and the signal line S1. The pixel electrode PE1 is electrically connected to the switching element SW1. The common electrode CE1 is arranged across the plurality of first pixels PX1.

The second liquid crystal panel PNL2 comprises a plurality of second pixels PX2, a plurality of scanning lines G2, and a plurality of signal lines S2 in the display area DA where images are displayed. The plurality of scanning lines G2 and the plurality of signal lines S2 intersect with each other. Each of the scanning lines G2 overlaps the scanning line G1, and each of the signal lines S2 overlaps the signal line S1, in the third direction Z. In addition, the second liquid crystal panel PNL2 comprises a first driver DR12 and a second driver DR22 outside the display area DA. The plurality of scanning lines G2 are electrically connected to the first driver DR12. The plurality of signal lines S2 are electrically connected to the second driver DR22. The first driver DR12 and the second driver DR22 are included in the drive unit Dr2 shown in FIG. 1 and controlled by the controller CTR.

Each of the second pixels PX2 comprises a switching element SW2 and a pixel electrode PE2. The switching element SW2 is electrically connected to the scanning line G2 and the signal line S2. The pixel electrode PE2 is electrically connected to the switching element SW2. The common electrode CE2 is arranged across the plurality of second pixels PX2. In one example, the potential of the common electrode CE2 is the same as the potential of the common electrode CE1.

The second pixels PX2 described here are referred to as sub-pixels, color pixels, or the like and each of them comprises a color filter and corresponds to, for example, a red pixel which exhibits red, a green pixel which exhibits green, a blue pixel which exhibits blue, a white pixel which exhibits white, or the like. Such a second pixel PX2 is sectioned by, for example, two adjacent scanning lines G2 and two adjacent signal lines S2.

In contrast, the first pixel PX1 does not comprise a color filter. Each of the second pixels PX2 overlaps the first pixel PX1 in the third direction Z. The first pixel PX1 is configured to be driven in synchronization with the second pixel PX2.

In the second liquid crystal panel PNL2, the first driver DR12 supplies a scanning signal to each of the scanning lines G2. The second driver DR2 supplies a video signal to each of the signal lines S2. In the switching element SW2 electrically connected to the scanning line G2 to which the scanning signal is supplied, the signal line S2 is electrically conductive with the pixel electrode PE2, and a voltage corresponding to the video signal supplied to the signal line S2 is applied to the pixel electrode PE2. The liquid crystal layer LC2 is driven by an electric field generated between the pixel electrode PE2 and the common electrode CE2.

In the first liquid crystal panel PNL1, the first driver DR11 supplies a scanning signal to each of the scanning lines G1. At this time, each scanning line G1 is supplied with the same scanning signal as the scanning signal supplied to the overlapping scanning line G2. The second driver DR21 supplies a drive signal to each of the signal lines S1. At this time, each signal line S1 is supplied with the same signal as the video signal supplied to the overlapping signal line S2 (or a signal substantially equivalent to the video signal). The first pixel PX1 is thereby driven in synchronization with the overlapping second pixel PX2.

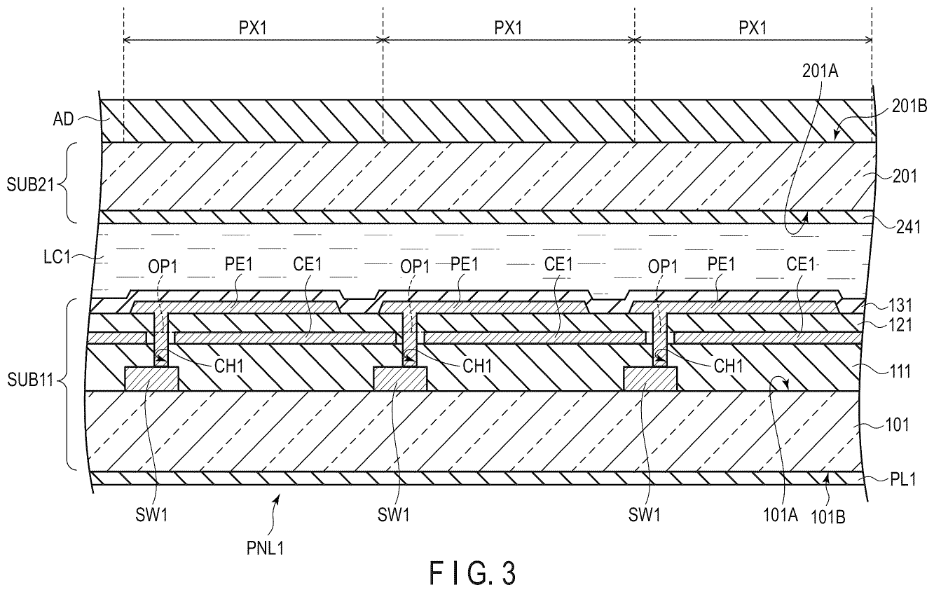

FIG. 3 is a cross-sectional view showing an example of a structure of the first liquid crystal panel PNL1.

The first liquid crystal panel PNL1 comprises a first substrate SUB11, a second substrate SUB21, and a liquid crystal layer LC1 held between the first substrate SUB11 and the second substrate SUB21.

The first substrate SUB11 comprises an insulating substrate (first insulating substrate) 101, insulating layers 111 and 121, and a first alignment film 131 in addition to the switching element SW1, the pixel electrode PE1, the common electrode CE1, and the like. In addition, the first substrate SUB11 also comprises the scanning lines G1, the signal lines S1, the first driver DR11 and the second driver DR21 shown in FIG. 2. The insulating substrate 101 has a main surface 101A opposed to the second substrate SUB21, and a main surface 101B on a side opposite to the main surface 101A.

The switching elements SW1 are formed on the main surface 101A side of the insulating substrate 101 and covered with the insulating layer 111. The switching elements SW1 are simply shown, and illustration of the scanning lines G1 and the signal lines S1 is omitted. In fact, the insulating layer 111 includes a plurality of insulating layers, and the switching elements SW1 include semiconductor layers and various electrodes formed on these layers.

The common electrode CE1 is formed on the insulating layer 111 and arranged across a plurality of first pixels PX1. The common electrode CE1 is covered with the insulating layer 121. The pixel electrode PE1 of each first pixel PX1 is formed on the insulating layer 121 and opposed to the common electrode CE1 via the insulating layer 121. Each pixel electrode PE1 is electrically connected to the switching element SW1 through an opening OP1 of the common electrode CE1, and a contact hole CH1 penetrating the insulating layers 111 and 121. The first alignment film 131 covers the pixel electrode PE1 and is in contact with the liquid crystal layer LC1.

The second substrate SUB21 comprises an insulating substrate (second insulating substrate) 201 and a second alignment film 241. The insulating substrate 201 has a main surface 201A opposed to the first substrate SUB11, and a main surface 201B on a side opposite to the main surface 201A. The second alignment film 241 is formed so as to be in contact with the main surface 201A across the plurality of first pixels PX1, and is in contact with the liquid crystal layer LC1.

The first polarizer PL1 is adhered to the main surface 101B of the insulating substrate 101, and the adhesive layer AD is adhered to the main surface 201B of the insulating substrate 201.

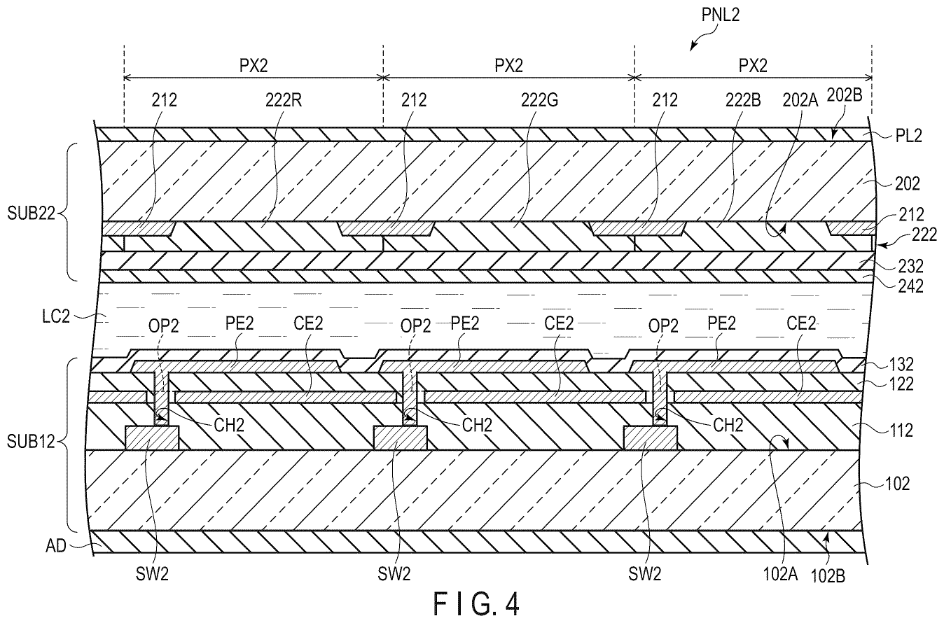

FIG. 4 is a cross-sectional view showing an example of a structure of the second liquid crystal panel PNL2.

The second liquid crystal panel PNL2 comprises a first substrate SUB12, a second substrate SUB22, and a liquid crystal layer LC2 held between the first substrate SUB12 and the second substrate SUB22.

The second substrate SUB12 comprises an insulating substrate (first insulating substrate) 102, insulating layers 112 and 122, and a first alignment film 132 in addition to the switching element SW2, the pixel electrode PE2, the common electrode CE2, and the like. In addition, the first substrate SUB12 also comprises the scanning lines G2, the signal lines S2, the first driver DR12 and the second driver DR22 shown in FIG. 2. The insulating substrate 102 has a main surface 102A opposed to the second substrate SUB22, and a main surface 102B on a side opposite to the surface 102A.

Although shown in a simplified manner, the switching element SW2 is formed on the main surface 102A side of the insulating substrate 102 and covered with the insulating layer 112. Illustration of the scanning lines G2 and the signal lines S2 connected to the switching elements SW2 is omitted. In fact, the insulating layer 112 includes a plurality of insulating layers, and the switching elements SW2 include semiconductor layers and various electrodes formed on these layers.

The common electrode CE2 is formed on the insulating layer 112 and arranged across the plurality of second pixels PX2. The common electrode CE2 is covered with the insulating layer 122. The pixel electrode PE2 of each first pixel PX2 is formed on the insulating layer 122 and opposed to the common electrode CE2 via the insulating layer 122. Each pixel electrode PE2 is electrically connected to the switching element SW2 through an opening OP2 of the common electrode CE2, and a contact hole CH2 penetrating the insulating layers 112 and 122. The first alignment film 132 covers the pixel electrode PE2 and is in contact with the liquid crystal layer LC2.

The second substrate SUB22 comprises an insulating substrate (second insulating substrate) 202, a light-shielding layer 212, a color filter layer 222, an overcoat layer 232, and a second alignment film 242. The insulating substrate 202 has a main surface 202A opposed to the first substrate SUB12, and a main surface 202B on a side opposite to the main surface 202A.

The light-shielding layer 212 is formed on the main surface 202A and arranged at the boundary between adjacent second pixels PX2. The color filter layer 222 includes a red color filter 222R, a green color filter 222G and a blue color filter 222B. The overcoat layer 232 covers the color filter layer 222. The second alignment film 242 covers the overcoat layer 232 and is in contact with the liquid crystal layer LC2.

An adhesive layer AD is adhered to the main surface 102B of the insulating substrate 102, and the insulating substrate 102 is adhered to the insulating substrate 201 shown in FIG. 3 by the adhesive layer AD. The second polarizer PL2 is adhered to the main surface 202B of the insulating substrate 202.

When the first liquid crystal panel PNL1 shown in FIG. 3 and the second liquid crystal panel PNL2 shown in FIG. 4 are compared, the first substrate SUB11 has the same configuration as the first substrate SUB12. In addition, unlike the second substrate SUB22, the second substrate SUB21 does not comprise a light shielding layer, a color filter layer, or an overcoat layer. The pixel electrode PE1 of the first pixel PX1 and the pixel electrode PE2 of the second pixel PX2 have the same shape and overlap each other. The pixel electrodes PE1 and PE2 will be described later in detail.

The insulating substrates 101, 102, 201, and 202 are transparent insulating substrates formed of a glass substrate, a resin substrate, or the like having a light-transmissive property. The pixel electrodes PE1 and PE2, the common electrode CE1, and the common electrode CE2 are transparent electrodes formed of, for example, a transparent conductive material such as indium tin oxide (ITO) or indium zinc oxide (IZO). The first alignment films 131 and 132, and the second alignment films 241 and 242 are both horizontal alignment films having an alignment restriction force along the X-Y plane, for example, are alignment films subjected to a photo-alignment treatment, but may be alignment films subjected to a rubbing treatment.

Next, an example of the shape of the pixel electrode PE corresponding to the pixel electrode PE1 of the first pixel PX1 and the pixel electrode PE2 of the second pixel PX2 will be described.

FIG. 5 is a view showing an example of the pixel electrode PE.

The pixel electrode PE includes a plurality of branch portions 31 extending in the first direction X and a trunk 32 extending in the second direction Y. The branch portions 31 and the trunk 32 are integrally formed and connected to each other. All the branch portions 31 are connected to one side of the trunk 32. In other words, the branch portions 31 extend from the trunk 32 in the same direction along the first direction X. In the example illustrated in the figure, the branch portions 31 extend from the trunk 32 toward the right side of the figure. In one example, a length Lx of the branch portions 31 along the first direction X is approximately 5 μm, and a pitch Py of the branch portions 31 along the second direction Y is approximately 5 to 6 μm. The pixel electrode PE having such a size is suitable for, for example, a high-definition panel of approximately 1000 ppi.

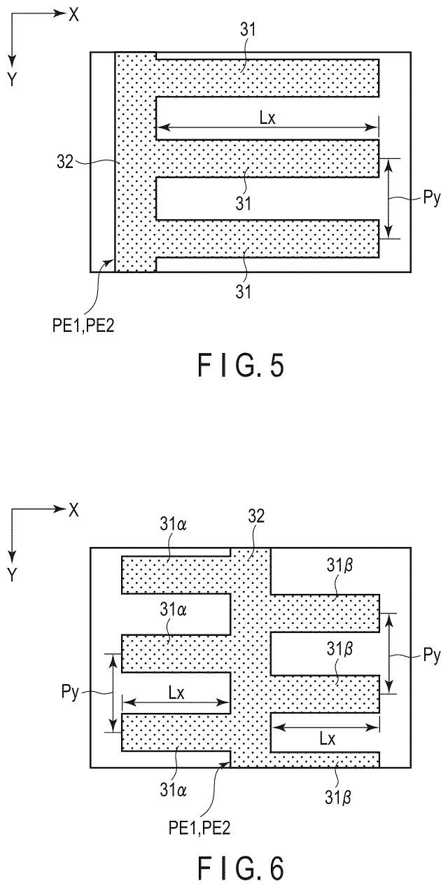

FIG. 6 is a view showing another example of the pixel electrode PE.

The pixel electrode PE in the example shown in FIG. 6 is different from the pixel electrode PE in the example shown in FIG. 5 in that a plurality of branch portions are connected to both sides of the trunk. In other words, the pixel electrode PE includes a plurality of branch portions 31a and a plurality of branch portions 31β extending in the first direction X, and a trunk 32 extending in the second direction Y. The trunk 32 is located between the branch portions 31a and the branch portions 31β. The plurality of branch portions 31a extend from the trunk 32 in the same direction along the first direction X. The plurality of branch portions 31β extend from the trunk 32 in the same direction along the first direction X. However, the branch portions 31β extend in the direction opposite to the branch portions 31α. In the example illustrated in the figure, the branch portions 31a extend from the trunk 32 toward the left side of the figure, and the branch portions 31β extend from the trunk 32 toward the right side of the figure. In one example, the length Lx of each of the branch portions 31a and 31β along the first direction X is approximately 7 μm, and the pitch Py of each of the branch portions 31a and 31β along the second direction Y is approximately 5 to 8 μm. The pixel electrode PE having such a size is suitable for, for example, a low-definition panel of approximately 400 ppi.

Next, overlapping of the pixel electrode PE1 and the pixel electrode PE2 will be described.

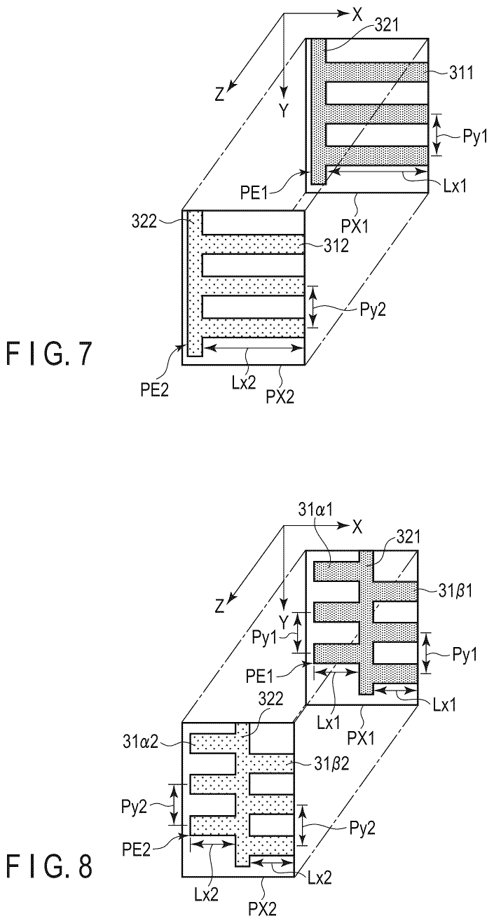

FIG. 7 is a view showing the pixel electrodes PE1 and PE2 having the shape shown in FIG. 5.

The pixel electrode PE1 has the same shape as the pixel electrode PE2. The pixel electrode PE1 includes branch portions 311 and a trunk 321, and the pixel electrode PE2 includes branch portions 312 and a trunk 322.

The number of branch portions 311 is the same as the number of branch portions 312. A length Lx1 of the branch portions 311 is the same as a length Lx2 of the branch portions 312. A pitch Py1 of the branch portions 311 is the same as a pitch Py2 of the branch portions 312.

The branch portions 312 overlap the branch portions 311, and the trunk 322 overlaps the trunk 321.

FIG. 8 is a view showing the pixel electrodes PE1 and PE2 having the shape shown in FIG. 6.

The pixel electrode PE1 has the same shape as the pixel electrode PE2. The pixel electrode PE1 includes branch portions 31α1 and 31β1, and a trunk 321. The pixel electrode PE2 includes branch portions 31α2 and 31β2, and a trunk 322.

The number of the branch portions 31α1 is the same as the number of the branch portions 31α2. A length Lx1 of the branch portions 31α1 is the same as a length Lx2 of the branch portions 31α2. A pitch Py1 of the branch portions 31α1 is the same as a pitch Py2 of the branch portions 31α2.

The number of the branch portions 31β1 is the same as the number of the branch portions 31β2. The length Lx1 of the branch portions 31β1 is the same as the length Lx2 of the branch portions 31β2. The pitch Py1 of the branch portions 31β1 is the same as the pitch Py2 of the branch portions 31β2.

The branch portions 31α2 overlap the branch portions 31α1, the branch portions 31β2 overlap the branch portions 31β1, and the trunk 322 overlaps the trunk 321.

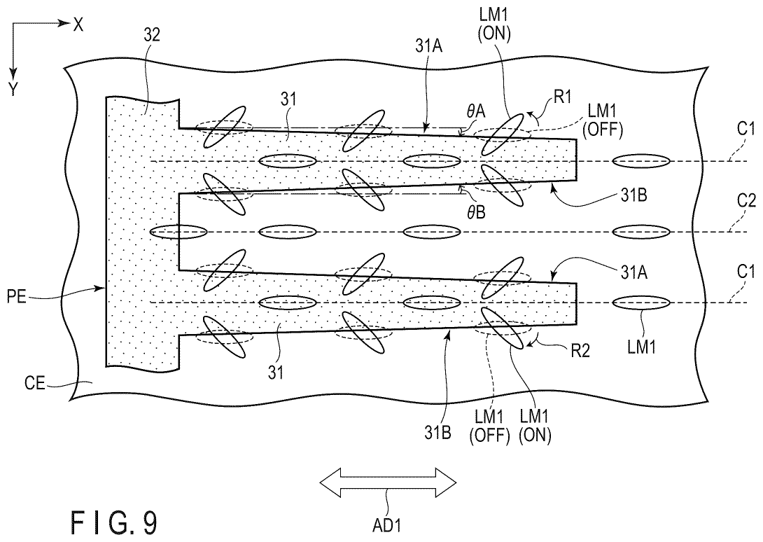

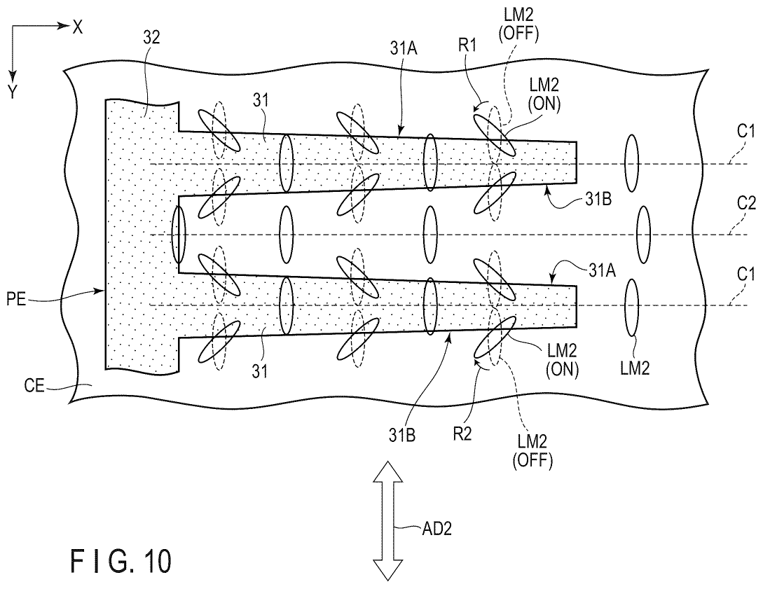

Next, the principle of operation will be described with reference to FIG. 9 and FIG. 10.

In each figure, the pixel electrode PE corresponds to the pixel electrodes PE1 and PE2, and the common electrode CE corresponds to the common electrodes CE1 and CE2. In addition, the aligned state of the liquid crystal molecules LM at the off time when no electric field is formed between the pixel electrode PE and the common electrode CE is represented by a dotted line, and the aligned state of the liquid crystal molecules LM at the on time when an electric field is formed between the pixel electrode PE and the common electrode CE is represented by a solid line.

Regarding the pixel electrode PE, the branch portions 31 have a shape tapered toward the tip on the right side of each figure. Then, the branch portions 31 include edges 31A and 31B opposed to each other in the second direction Y. The edge 31A is inclined clockwise with respect to the axis along the first direction X at an angle A. The edge 31B is inclined counterclockwise with respect to the axis along the first direction X at an angle θB. The angle θA is substantially equal to the angle θB, for example, an angle larger than or equal to 1°.

FIG. 9 is a view showing an aligned state of liquid crystal molecules LM1. The liquid crystal layer LC containing liquid crystal molecules LM1 is a positive type with a positive dielectric anisotropy. The liquid crystal layer LC corresponds to the liquid crystal layers LC1 and LC2. An initial alignment direction AD1 of the liquid crystal molecules LM1 at the off time is parallel to the first direction X. In other words, the liquid crystal molecules LM1 are initially aligned such that their long axes are parallel to the first direction X, as represented by the dotted line. The initial alignment direction AD1 is parallel to the directions of extension of the branch portions 31. In order to form such an initial alignment state, the alignment treatment directions of the first alignment film 13 and the second alignment film 24 which are in contact with the liquid crystal layer LC are parallel to the first direction X.

At the on time, an electric field which intersects with the edges 31A and 31B occurs on the X-Y plane. The liquid crystal molecules LM1 rotate such that their long axes are substantially parallel to the electric field. For example, the liquid crystal molecules LM1 in the vicinity of the edge 31A rotate in the rotation direction R1 which is a counterclockwise rotation. The liquid crystal molecules LM1 in the vicinity of the edge 31B rotate in the rotation direction R2 which is a clockwise rotation. In other words, with respect to the branch portions 31, the rotation directions of the liquid crystal molecules LM1 are different from each other on the edge 31A side and the edge 31B side.

In contrast, the liquid crystal molecules LM1 rotating in the rotation direction R1 and the liquid crystal molecules LM1 rotating in the rotation direction R2 compete with each other, in the vicinity of a center line C1 between the edge 31A and the edge 31B of each branch portion 31. For this reason, the liquid crystal molecules LM1 in such an area hardly rotate at the on time. Similarly, the liquid crystal molecules LM1 hardly rotate at the on time, either, in the vicinity of a center line C2 between the edge 31A of one branch portion 31 and the edge 31B of the other branch portion 31, of two branch portions 31 adjacent in the second direction Y.

FIG. 10 is a view showing an aligned state of the liquid crystal molecules LM2. The liquid crystal layer LC containing liquid crystal molecules LM2 is a negative type with a negative dielectric anisotropy. The liquid crystal layer LC corresponds to the liquid crystal layers LC1 and LC2. An initial alignment direction AD2 of the liquid crystal molecules LM2 at the off time is parallel to the second direction Y. In other words, the liquid crystal molecules LM2 are initially aligned such that their long axes are parallel to the second direction Y, as represented by the dotted line. The initial alignment direction AD2 is orthogonal to the directions of extension of the branch portions 31. In order to form such an initial alignment state, the alignment treatment directions of the first alignment film 13 and the second alignment film 24 which are in contact with the liquid crystal layer LC are parallel to the second direction Y.

The liquid crystal molecules LM2 at the on time rotate on the X-Y plane such that their long axes are substantially orthogonal to the electric field. For example, the liquid crystal molecules LM2 in the vicinity of the edge 31A rotate in the rotation direction R1 which is a counterclockwise rotation. The liquid crystal molecules LM2 in the vicinity of the edge 31B rotate in the rotation direction R2 which is a clockwise rotation.

In contrast, the liquid crystal molecules LM2 hardly rotate at the on time, in the vicinity of the center line C1 of each branch portion 31 and the center line C2 between the branch portions 31 adjacent in the second direction Y.

Thus, the rotation directions of the liquid crystal molecules LM are aligned, in the vicinity of the edge 31A of the branch portion 31. In addition, the rotation directions of the liquid crystal molecules LM are also aligned in the vicinity of the edge 31B. However, the rotation direction of the liquid crystal molecules LM in the vicinity of the edge 31B is opposite to the rotation direction of the liquid crystal molecules LM in the vicinity of the edge 31A. For this reason, an area where the liquid crystal molecules LM do not rotate is periodically formed along the second direction Y. Thus, since the response speed upon applying a voltage is made faster and the liquid crystal molecules LM are less likely to rise due to the vertical electric field as compared with the general FFS mode, the alignment stability can be made higher than that in a case where a positive liquid crystal layer is applied.

Next, the diffraction phenomenon of light passing through the liquid crystal panel will be described.

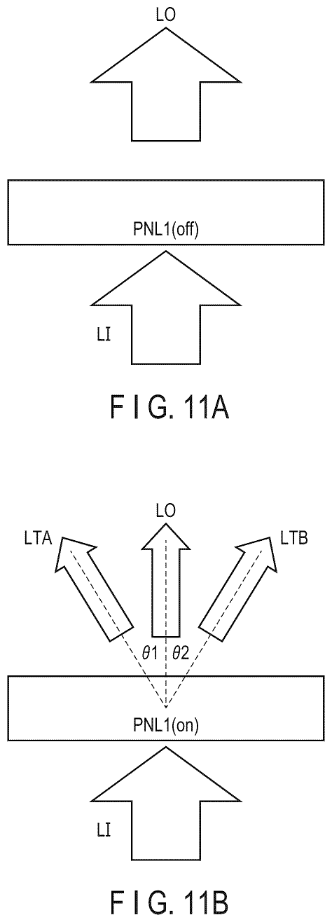

FIG. 11A and FIG. 11B are views illustrating the diffraction phenomenon of transmitted light. Only the configuration necessary for description is shown in FIG. 11A and FIG. 11B. A case where the liquid crystal layer includes the negative liquid crystal molecules LM2 shown in FIG. 10 will be described.

FIG. 11A is a view illustrating the optical action in the first liquid crystal panel PNL1 in the off state (OFF). When no voltage is applied to the liquid crystal layer LC1, the liquid crystal molecules are initially aligned. In such an off state, the polarization state of the incident light LI of the first liquid crystal panel PNL1 is equivalent to the polarization state of the transmitted light L0 of the first liquid crystal panel PNL1.

FIG. 11B is a view illustrating the optical action in the first liquid crystal panel PNL1 in the on state (ON).

As described with reference to FIG. 10, the liquid crystal molecules LM2 in the vicinity of the edge 31A uniformly rotate in the counterclockwise rotation direction R1, and the liquid crystal molecules LM2 in the vicinity of the edge 31B uniformly rotate in the clockwise rotation direction R2. At this time, the aligned state of the liquid crystal molecules LM2 overlapping the entire pixel electrode PE functions as a diffraction grating.

The incident light LI perpendicular to the first liquid crystal panel PNL1 will be reviewed here. The incident light LI is linearly polarized light. When the first liquid crystal panel PNL1 is in the on state, the incident light LI is diffracted into transmitted light LTA and transmitted light LTB.

The transmitted light LTA is diffracted to the left side of the figure with respect to the normal of the first liquid crystal panel PNL1, and is converted into circularly polarized light (or elliptically polarized light).

The transmitted light LTB is diffracted to the right side of the figure with respect to the normal of the first liquid crystal panel PNL1, and is converted into circularly polarized light (or elliptically polarized light). A diffraction angle θ2 of the transmitted light LTB is equivalent to a diffraction angle θ1 of the transmitted light LTA. The intensity of the transmitted light L0 parallel to the incident light LI is reduced with respect to the incident light LI.

Thus, the incident light LI is diffracted to the right or left side of the figure, and the transmitted light L0 parallel to the direction perpendicular to the first liquid crystal panel PNL1, i.e., the incident light LI is reduced. Furthermore, the transmitted light L0 is in the polarized state (linearly polarized light) equivalent to the incident light L1, and cannot pass through a polarizer having a polarization axis orthogonal to that of the transmitted light L0. For this reason, improving the front luminance when the display device is viewed from the front side is required.

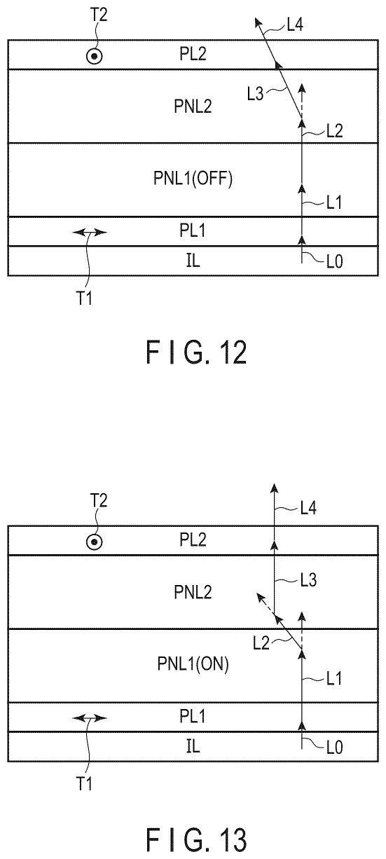

FIG. 12 is a view illustrating the optical action of the display device DSP according to the present embodiment. FIG. 12 shows a case where the first liquid crystal panel PNL1 is in the off state. In other words, no potential difference is formed between the pixel electrode PE1 and the common electrode CE1 shown in FIG. 3.

The illumination device IL emits light L0 along the normal. The first polarizer PL1 transmits linearly polarized light L1 parallel to the transmission axis T1, of the light L0. The linearly polarized light L1 travels straight without being diffracted in the first liquid crystal panel PNL1. Transmitted light L2 of the first liquid crystal panel PNL1 is diffracted on the second liquid crystal panel PNL2 and passes through the second liquid crystal panel PNL2 as diffracted light L3. Part of the transmitted light L2 travels straight through the second liquid crystal panel PNL2, and description of this straight traveled light is omitted here. The second polarizer PL2 transmits linearly polarized light L4 parallel to the transmission axis T2, of the diffracted light L3 of the second liquid crystal panel PNL2.

FIG. 13 is a view illustrating the optical action of the display device DSP according to the present embodiment. FIG. 13 shows the case where the first liquid crystal panel PNL1 is in the on state. In other words, a potential difference is formed between the pixel electrode PE1 and the common electrode CE1 shown in FIG. 3.

The illumination device IL emits light L0 along the normal. The first polarizer PL1 transmits linearly polarized light L1 parallel to the transmission axis T1, of the light L0. The linearly polarized light L1 is diffracted at the first liquid crystal panel PNL1 and passes through the first liquid crystal panel PNL1 as diffracted light L2 traveling in a direction oblique to the normal. Part of the linearly polarized light L1 travels straight through the first liquid crystal panel PNL1, but description of this straight traveled light is omitted here.

The diffracted light L2 is diffracted again at the second liquid crystal panel PNL2 and passes through the second liquid crystal panel PNL2 as diffracted light L3 along the normal. Part of the diffracted light L2 travels straight, and its description is omitted here. The second polarizer PL2 transmits the linearly polarized light L4 parallel to the transmission axis T2, of the diffracted light L3.

Therefore, according to the present embodiment, the transmittance of the linearly polarized light L4 along the normal is increased, and the front luminance can be improved.

Next, a relationship between a liquid crystal applied voltage and a mode efficiency will be described.

The modal efficiency will be described here. A test cell having a liquid crystal panel sandwiched between the first polarizer PL1 and the second polarizer PL2 is prepared. In this test cell, when the front luminance where the first polarizer PL1 and the second polarizer PL2 satisfy the crossed-Nicols relationship is referred to as first front luminance, and the front luminance where the first polarizer PL1 and the second polarizer PL2 satisfy the parallel-Nicols relationship is referred to as second front luminance, a ratio represented by (first front luminance/second front luminance) is referred to as a mode efficiency.

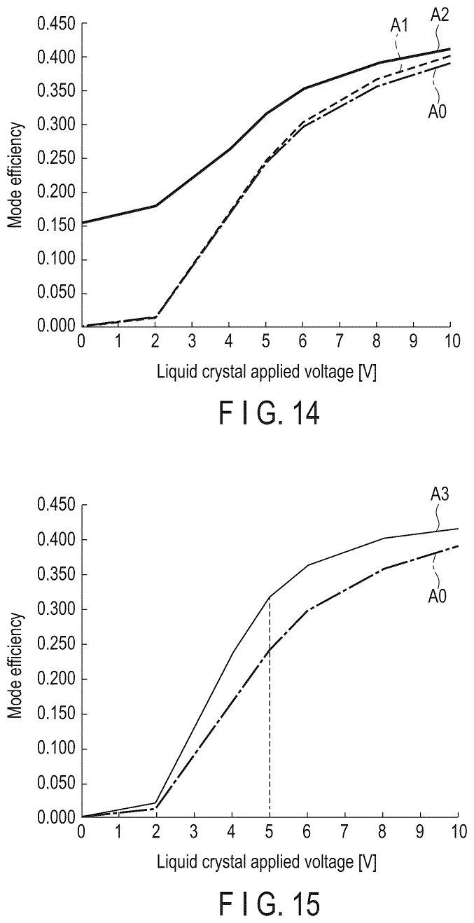

FIG. 14 is a graph showing a relationship of the mode efficiency to the liquid crystal applied voltage. A horizontal axis of the graph indicates the liquid crystal applied voltage, which corresponds to the voltage applied to the liquid crystal layer LC2 of the second liquid crystal panel PNL2. A vertical axis of the graph indicates the mode efficiency.

A first test cell serving as a reference does not comprise the first liquid crystal panel PNL1, but holds the second liquid crystal panel PNL2 between the first polarizer PL1 and the second polarizer PL2. In this first test cell, a measurement result of the mode efficiency to the liquid crystal applied voltage is represented as “A0” in the graph.

In a second test cell, the first liquid crystal panel PNL1 and the second liquid crystal panel PNL2 are sandwiched between the first polarizer PL1 and the second polarizer PL2. In this second test cell, a measurement result of the mode efficiency to the liquid crystal applied voltage in a case where the voltage applied to the liquid crystal layer LC1 of the first liquid crystal panel PNL1 is fixed to 0V is referred to as “A1” in the graph. In addition, in this second test cell, a measurement result of the mode efficiency to the liquid crystal applied voltage in a case where the voltage applied to the liquid crystal layer LC1 of the first liquid crystal panel PNL1 is fixed to 5V is referred to as “A2” in the graph.

It has been confirmed that the measurement result A1 in the case where the liquid crystal applied voltage of the first liquid crystal panel PNL1 is 0V has the same tendency as the measurement result A0 of the first test cell.

It has been confirmed that, in the measurement result A2 in the case where the liquid crystal applied voltage of the first liquid crystal panel PNL1 is 5V, the mode efficiency is increased as compared to the measurement result A0 of the first test cell. In other words, it has been confirmed that the front luminance is improved by applying the voltage to the liquid crystal layer LC1 of the first liquid crystal panel PNL1.

FIG. 15 is a graph showing the relationship of the mode efficiency to the liquid crystal applied voltage. A horizontal axis of the graph indicates the liquid crystal applied voltage, which corresponds to the voltage applied to the liquid crystal layer LC2 of the second liquid crystal panel PNL2. A vertical axis of the graph indicates the mode efficiency.

In the second test cell, a measurement result of the mode efficiency to the liquid crystal applied voltage in a case where the voltage applied to the liquid crystal layer LC1 of the first liquid crystal panel PNL1 is equivalent to the voltage applied to the liquid crystal layer LC2 of the second liquid crystal panel PNL2 is referred to as “A3” in the graph.

It has been confirmed that, in the measurement result A3 of the second test cell, the mode efficiency is increased as compared to the measurement result A0 of the first test cell. Moreover, the mode efficiency in the case where the liquid crystal applied voltage is 0 V in the measurement result A3 is substantially zero similarly to that in the case of the measurement result A0, and the mode efficiency in the case where the liquid crystal applied voltage is 5 V is approximately 1.3 times as large as that in the case of the measurement result A0. For this reason, the contrast ratio of the measurement result A3 is increased by approximately 30% as compared to that in the case of the measurement result A0.

It has been confirmed that the front luminance and the contrast ratio are improved by thus equivalently controlling the voltage applied to the liquid crystal layer LC1 of the first liquid crystal panel PNL1 and the voltage applied to the liquid crystal layer LC2 of the second liquid crystal panel PNL2.

According to the inventors' study, it has been confirmed that the front luminance and the contrast ratio can be improved even if the liquid crystal applied voltage of the first liquid crystal panel PNL1 does not completely match the liquid crystal applied voltage of the second liquid crystal panel PNL2. For example, the liquid crystal applied voltage of the second liquid crystal panel PNL2 may be assigned so as to correspond to the number of gradations to be displayed while the liquid crystal applied voltage of the first liquid crystal panel PNL1 may be assigned so as to correspond to the smaller number of gradations than the number of gradations to be displayed.

Next, the inventors have compared the mode efficiency by comparing the display device DSP of the present embodiment with the display device of the FFS mode.

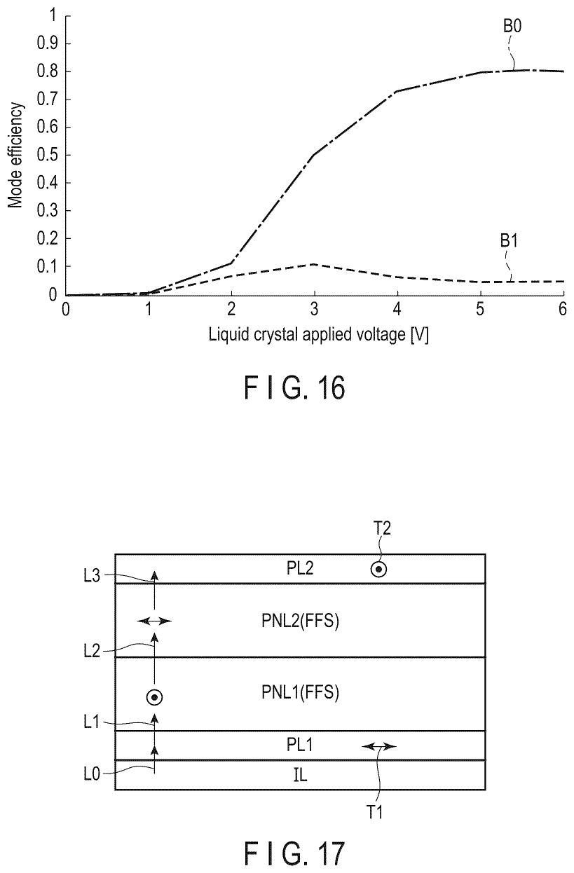

FIG. 16 is a graph showing the relationship of the mode efficiency to the liquid crystal applied voltage. A horizontal axis of the graph indicates the liquid crystal applied voltage, which corresponds to the voltage applied to the liquid crystal layer LC2 of the second liquid crystal panel PNL2. A vertical axis of the graph indicates the mode efficiency.

A third test cell does not comprise the first liquid crystal panel PNL1, but holds the second liquid crystal panel PNL2 of the FFS mode between the first polarizer PL1 and the second polarizer PL2. In this third test cell, a measurement result of the mode efficiency to the liquid crystal applied voltage is referred to as “B0” in the graph.

In a fourth test cell, the first liquid crystal panel PNL1 and the second liquid crystal panel PNL2 which are both in the FFS mode are sandwiched between the first polarizer PL1 and the second polarizer PL2. In this fourth test cell, a measurement result of the mode efficiency to the liquid crystal applied voltage in a case where the voltage applied to the liquid crystal layer LC1 of the first liquid crystal panel PNL1 is equivalent to the voltage applied to the liquid crystal layer LC2 of the second liquid crystal panel PNL2 is referred to as “B1” in the graph. It has been confirmed that, in the measurement result B1 of the fourth test cell, the mode efficiency is remarkably reduced as compared to the measurement result B0 of the third test cell. In addition, according to the inventors' study, it has been confirmed that coloring occurred in the fourth test cell and that colors different from desired colors were displayed.

FIG. 17 is a view illustrating an optical action in the display device DSP of the FFS mode. It is assumed that both the first liquid crystal panel PNL1 and the second liquid crystal panel PNL2 are in the on state.

The illumination device IL emits light L0 along the normal. The first polarizer PL1 transmits linearly polarized light L1 parallel to the transmission axis T1, of the light L0. When the linearly polarized light L1 passes through the liquid crystal layer LC1 in the first liquid crystal panel PNL1, the polarization axis is rotated under the influence of retardation.

The transmitted light L2 that has passed through the first liquid crystal panel PNL1 is linearly polarized light but, when the light passes through the liquid crystal layer LC2 in the second liquid crystal panel PNL2, the polarization axis is rotated under the influence of retardation. In other words, the transmitted light L3 that has passed through the second liquid crystal panel PNL2 is linearly polarized, and its polarization axis is orthogonal to the transmission axis T2 of the second polarizer PL2.

Thus, in the display device of the FFS mode, most part of the transmitted light L3 that has passed through the first liquid crystal panel PNL1 and the second liquid crystal panel PNL2 in the on state does not pass through the second polarizer PL2. For this reason, even if the panels are driven in the same manner as the display panel of the present embodiment, the front luminance cannot be improved.

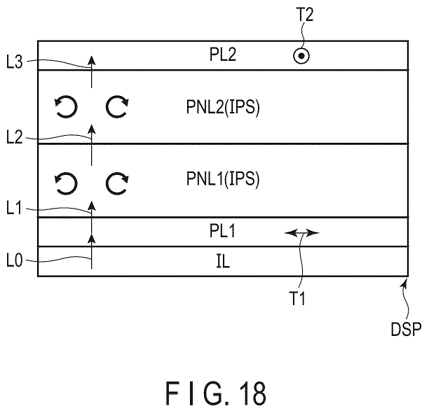

FIG. 18 is a view illustrating the optical action in the display device according to the present embodiment. It is assumed that both the first liquid crystal panel PNL1 and the second liquid crystal panel PNL2 are in the on state.

The illumination device IL emits light L0 along the normal. The first polarizer PL1 transmits linearly polarized light L1 parallel to the transmission axis T1, of the light L0. The linearly polarized light L1 is diffracted and converted into clockwise circularly polarized light or counterclockwise circularly polarized light when passing through the liquid crystal layer LC1 in the first liquid crystal panel PNL1. The transmitted light L2 that has passed through the first liquid crystal panel PNL1 is circularly polarized light, and becomes oblique light inclined to the normal as described with reference to FIG. 13.

The transmitted light L2 is diffracted again when passing through the liquid crystal layer LC2 in the second liquid crystal panel PNL2. The transmitted light L3 that has passed through the second liquid crystal panel PNL2 is circularly polarized light, and becomes front light along the normal and passes through the second polarizer PL2 as described with reference to FIG. 13.

Therefore, according to the display device DSP of the present embodiment, unlike the display device of the FFS mode, the front luminance can be improved by driving the first liquid crystal panel PNL1 in synchronization with the second liquid crystal panel PNL2.

As described above, a display device capable of improving the front luminance can be provided according to the present embodiment.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A display device comprising:
a first liquid crystal panel;
a second liquid crystal panel adhered to the first liquid crystal panel;
an illumination device illuminating the first liquid crystal panel;
a first polarizer located between the illumination device and the first liquid crystal panel; and
a second polarizer opposed to the second liquid crystal panel, wherein
each of the first liquid crystal panel and the second liquid crystal panel comprises:
a first substrate comprising a first insulating substrate, a switching element, a common electrode arranged across a plurality of pixels, a pixel electrode arranged in each of the pixels, electrically connected to the switching element, and opposed to the common electrode, and a first alignment film;
a second substrate comprising a second insulating substrate and a second alignment film, and opposed to the first substrate; and
a liquid crystal layer arranged between the first substrate and the second substrate,
the pixel electrode includes a plurality of branch portions extending in a first direction, and a trunk extending in a second direction intersecting with the first direction and connected to the plurality of branch portions, and
the pixel electrode of the first liquid crystal panel and the pixel electrode of the second liquid crystal panel have a same shape and overlapping each other.

2. The display device of claim 1, wherein
in the first liquid crystal panel, the second alignment film is in contact with the second insulating substrate, and
in the second liquid crystal panel, the second substrate further comprises a light-shielding layer, a color filter layer, and an overcoat layer between the second insulating substrate and the second alignment film.

3. The display device of claim 2, wherein
the plurality of branch portions are connected to one side of the trunk.

4. The display device of claim 3, wherein
the branch portions and the trunk at the pixel electrode of the first liquid crystal panel overlap the branch portions and the trunk at the pixel electrode of the second liquid crystal panel, respectively.

5. The display device of claim 2, wherein
the plurality of branch portions are connected to both sides of the trunk.

6. The display device of claim 5, wherein
the branch portions and the trunk at the pixel electrode of the first liquid crystal panel overlap the branch portions and the trunk at the pixel electrode of the second liquid crystal panel, respectively.

7. The display device of claim 1, wherein
the plurality of branch portions are connected to one side of the trunk.

8. The display device of claim 7, wherein
the branch portions and the trunk at the pixel electrode of the first liquid crystal panel overlap the branch portions and the trunk at the pixel electrode of the second liquid crystal panel, respectively.

9. The display device of claim 1, wherein
the plurality of branch portions are connected to both sides of the trunk.

10. The display device of claim 9, wherein
the branch portions and the trunk at the pixel electrode of the first liquid crystal panel overlap the branch portions and the trunk at the pixel electrode of the second liquid crystal panel, respectively.

11. The display device of claim 1, wherein
the liquid crystal layer has a negative dielectric anisotropy, and
liquid crystal molecules of the liquid crystal layer are subjected to initial alignment in the second direction.

12. The display device of claim 1, wherein
the liquid crystal layer has a positive dielectric anisotropy, and
liquid crystal molecules of the liquid crystal layer are subjected to initial alignment in the first direction.

13. The display device of claim 1, wherein
a first pixel of the first liquid crystal panel overlaps a second pixel of the second liquid crystal panel, and
the first pixel is configured to be driven in synchronization with the second pixel.
